(19) United States
(12) Patent Application Publication
(10) Pub. No.: US 2023/0135003 A1
(43) Pub. Date: May 4, 2023

(54) PRESSURE VESSEL TEMPERATURE CONTROL FOR BULK PROCESSING IN HIGH PRESSURE APPLICATION

(71) Applicant: Avure Technologies Incorporated, Middletown, OH (US)

(72) Inventors: Karl Magnus Malmberg, Mjölby (SE); Jan Olof Viberg, Helsingborg (SE); Alan C. Fullenkamp, West Chester, OH (US); Christopher Robin Morrison, Lebanon, OH (US)

(73) Assignee: Avure Technologies Incorporated, Middletown, OH (US)

(21) Appl. No.: 17/906,380

(22) PCT Filed: Mar. 24, 2021
(86) PCT No.: PCT/US2021/023977

§ 371 Date: Sep. 15, 2022

Related U.S. Application Data
(60) Provisional application No. 63/006,550, filed on Apr. 7, 2020.
(60) Provisional application No. 63/001,113, filed on Mar. 27, 2020.

(51) Int. Cl. A23L 3/015; A23L 3/00; A23C 3/03; A23L 3/16

(52) U.S. Cl. CPC A23L 3/0155; A23L 3/003; A23C 3/03; A23L 3/16

(57) ABSTRACT

A high pressure processing system includes a pressure vessel configured to receive a basket or container, a high pressure pump configured to pump a pressure media to the pressure vessel to raise pressure in the pressure vessel, and a heater or cooler system, such as thermal jacket surrounding the pressure vessel, and the thermal jacket contains heat transfer media that is heated and cooled. The high pressure processing system, in addition to processing food stuff at a very high pressure of at least 2,000 bar also processes the food stuff at any high temperature of about 40° C. or greater.

### CROSS-REFERENCE(S) TO RELATED APPLICATIONS

This patent application claims priority of U.S. Patent Application Ser. No. 63/006,550, filed on Apr. 7, 2020, this patent application also claims priority of U.S. Patent Application Ser. No. 63/001,113, filed on Mar. 27, 2020, the entire disclosures of which are hereby incorporated by reference herein for all purposes.

### BACKGROUND

High pressure processing (HPP) is used to reduce the microbial load on foods, beverages, cosmetics, pharmaceuticals and other products without altering the characteristics of the processed product. The pressure level required for HPP to be successful is typically at least 2,000 bar.

Traditional equipment for treatment of beverages and other liquids as well as pumpable foods and other substances by HPP is based on the processing of the products after having been placed as individual units into flexible packaging, for example, bottles, cartons or pouches. The individual units are grouped or consolidated within a larger reusable load basket which is sized and shaped to fit into a wire wound high pressure vessel (also referred to as “wire wound vessel” or “high pressure vessel”).

Such high pressure vessel is filled with water which serves as the pressurizing medium. Once the wire wound vessel has been filled and closed, high capacity pumps introduce additional water into the pressure vessel so that the pressure therein is increased from about 2,000 to 10,000 bar. This pressure is maintained for a sufficient length of time, from a few seconds to several minutes, to reduce the microbial load on the products being treated. The particular pressure level and the time duration of such pressure are specific to the product being processed.

Once the desired level of inactivation of the microorganisms has been achieved, the pressure in the vessel is released and the load basket is removed from therein so that the individual packages or units can be extracted. The processed product has, after being exposed to high pressure and hold time, been pasteurized, the microbial load has been reduced, and an extended shelf life has been achieved.

High pressure applications for food stuff are run at lower temperature, normally 2-30° C. due to the necessity to keep the cool chain intact. A high pressure application for food is normally run with water or pressure media pressure levels above 2,000 bar and hold times longer than 20 seconds (typical is 6,000 bar with 3 minutes hold time).

However, some food stuffs are required to achieve a particular minimum temperature that is higher than the temperatures normally used in high pressure processing. The present disclosure can address this shortcoming and has further advantages.

### SUMMARY

The present disclosure is directed to using very high pressures and higher process temperatures to treat products. In the past, high pressure processing has been used to reduce the microbial count in many types of food and other products. In this disclosure, “product” is intended to cover food stuff, cosmetics, pharmaceuticals, and various types of organic substances, for example. In the past, the aim of high pressure processing has been to keep the product at a relatively low temperature normally 4-29° C.

Water is used as a pressure media for applying high-pressure to the products being processed. Intensifiers are used to increase the pressure of the water to the desired level. When applying such pressure the water experiences an adiabatic temperature rise of about 3° C. per 1,000 bar. Typically, the adiabatic temperature rise has not been an issue in the past, due to the water starting out at a low enough temperature to remain within a desired temperature range in spite of the adiabatic temperature rise. Once the pressure is released, the temperature of the water and processed product start to decrease correspondingly.

However, some regulations require heat treatment to certain minimum temperatures for certain products. To meet the regulations for processing milk, for example, milk must be heated to preferably 55° C. and maintained within a relatively close temperature range.

According to the present disclosure, the pressure vessel is equipped with one or more heating and cooling systems in order to control the temperature range to meet any temperature requirement for products while undergoing pressurization.

In one embodiment, the pressure media is used to heat or cool the pressure vessel and/or products therein using a system of temperature sensors which provide feedback to a controller.

In one embodiment, the controller takes the adiabatic temperature rise in calculating the pressure media temperature to meet any desired processing temperature for the particular product.

In one embodiment, the temperature of the pressure media water to the pressure vessel is controlled, as well as also computing the adiabatic temperature rise and fall of the water based on the processing pressure. When a different pressure media is used, the adiabatic temperature rise can also be computed for the pressure media being used.

In one embodiment where a pressure vessel is surrounded in an oil bath, the oil bath can be converted into an oil-filled thermal jacket by recirculating the oil through an auxiliary oil heating and cooling system. The oil-filled thermal jacket partly surrounds the pressure vessel within which is one or more baskets and/or containers holding the products. Accordingly, the oil-filled thermal jacket can be used to apply or remove heat therefrom.

In one embodiment, a heat blanket can be wrapped around the pressure vessel. The heat blanket supplies heat through electrical resistance heating elements. In addition to the oil-filled thermal jacket, the heat blanket, and the pressure media, other heating and cooling systems can also be constructed to apply or remove heat from the pressure vessel to control processing temperatures.

In one embodiment, the aim of the present disclosure is control of processing temperatures while the product is being pressurized. In this manner, the product sees microorganism inactivation through both pressure and heat.

In other embodiments, the product may be sensitive to high temperatures caused by adiabatic heating, in which case, the aim of the disclosure is not to subject the product to the deleterious high temperatures while being processed at high pressures for microorganism inactivation. Accordingly, the high pressure processing system may also be provided with cooling systems as well as heating systems, which are both under the control of a controller.

The system of this disclosure may be used to process products at high pressures with temperatures controlled within desired ranges that has not been the case for high pressure processing systems. Generally, processing temperatures were allowed to float in accordance with the adiabatic temperature rise for the given pressure. In the present disclosure, the temperature is actively monitored and controlled within a desired range.

The present disclosure provides advantages. For example, the system has already been described useful in processing dairy products. The system may also be used at operating temperatures of at least 130° C. or higher in situations for both elevated temperatures and pressures for sterilization. Such operating pressures may be as high as 8,000 bar or even higher. Thus, for example, the system of this disclosure may be used for Pressure Assisted Temperature Sterilization (PATS) or Temperature Assisted Pressure Sterilization (TAPS).

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of one embodiment of a high pressure processing system in accordance with one embodiment;

FIG. 2 is a schematic illustration of one embodiment of a high pressure processing system with process temperature control;

FIG. 3 is a schematic illustration of one embodiment of a high pressure processing system with process temperature control; and

FIG. 4 is a schematic illustration of a temperature control system for high pressure processing in accordance with the embodiments of this disclosure.

### DETAILED DESCRIPTION

In one embodiment, the present disclosure provides a temperature control system to control the processing temperature for products, such as dairy products, in a High Pressure Processing (HPP) pressure vessel. With this system and method the temperature inside the pressure vessel can be maintained within a very narrow temperature band which is needed in order for the product, such as dairy product or other food stuff, to reach its desired parameters or features, such as nutrition, shelf life, and the like. In this disclosure, dairy product and food stuff may be used as examples to illustrate the aspects of temperature control during high pressure processing, however, the disclosure is not limited to any particular product.

The present application refers to a “product” or “products” that are subjected to or treated by high pressure processing with temperature control of the present disclosure. Such product(s) may include all manner of foods, including pumpable foods or beverages, as well as non-food products, such as cosmetics, pharmaceuticals, and organic materials and substances wherein the control of pathogens and microorganisms is desirable.

In an example, a “dairy product” is any of the products made from or derived from ruminant animals, such as cows, goats, sheep, deer, and the like. Dairy products are described as representative examples of products. However, the products are not limited to dairy products or food stuff, but, may also include things that benefit from deactivation of microorganisms, such as cosmetics, pharmaceuticals, and various types of organic materials and substances

High pressure processing of current food applications is run at temperatures as low as possible (normally 4-29° C.) in order not to interrupt the cool chain that normally is key to establish the desired shelf life.

For dairy and other products, for example, a higher temperature should be achieved. In one example, dairy products should be exposed to minimum of about 55° C., for example. In one embodiment, the present system is aimed at achieving high pressure processing with temperature control in the range of about 45 to 65° C.

A high pressure food application is in many ways a superior method to achieve a microbial inactivation within food, because such processing does not rely on using elevated temperature levels that may destroy or ruin food nutrition, taste, and texture. By usage of high pressure and hold time, shelf life is extended, and nutrition remains. Further, by usage of high pressure and hold time the food manufacturer may use a clean label and not be forced to use preservatives to extend shelf life. However, as the examples show, it can be desirable to achieve further heating or cooling of some products.

High pressure vessels have been commercially available for more than 25 years. They exist in different configurations and sizes. All systems though include a pressure vessel that is able to withstand very high pressure levels. The most common pressure media used is water, but also water with additives may be used. The present disclosure can be applied to retro-fitting existing pressure vessels with temperature control systems, or in the construction of new pressure vessels with temperature control systems.

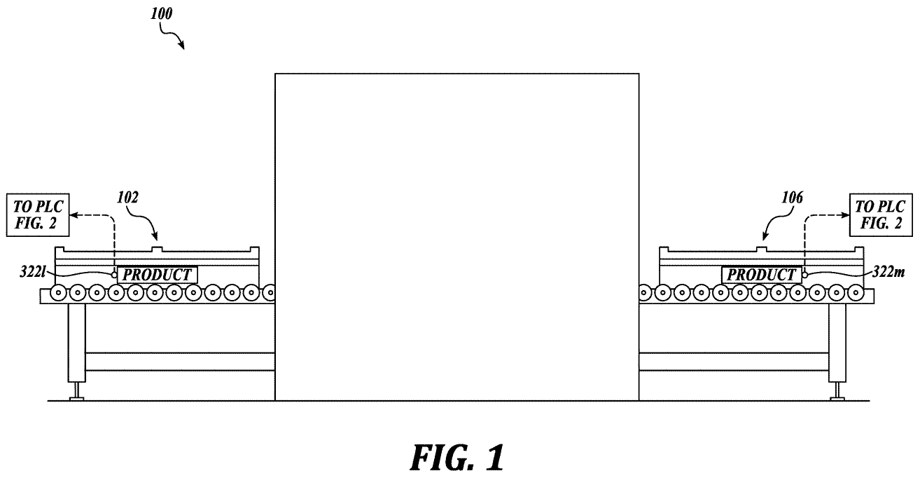

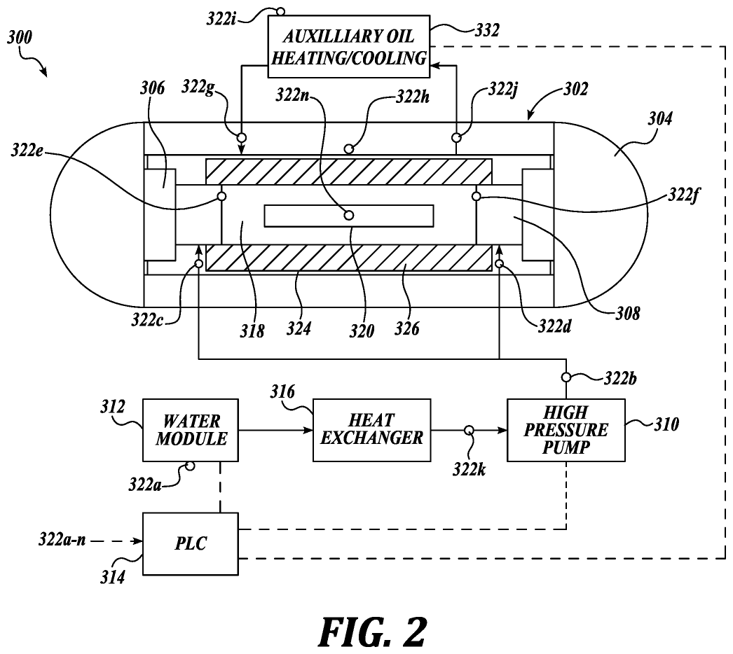

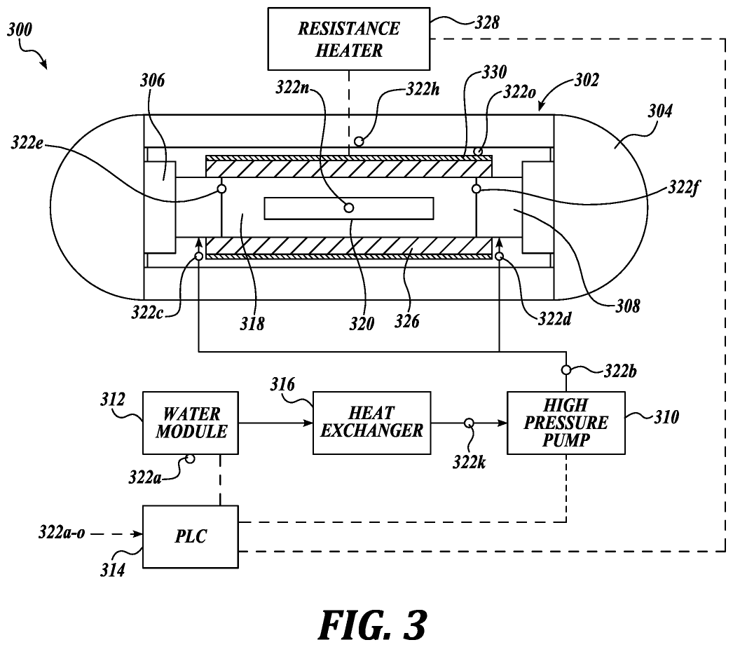

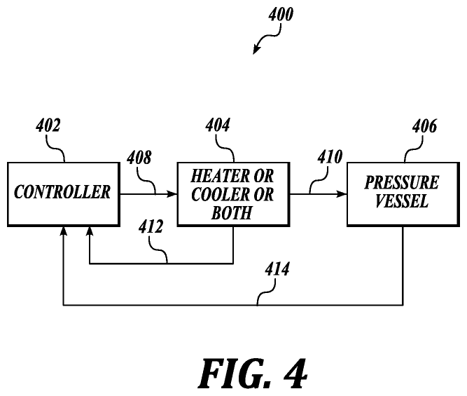

FIG. 1 is a diagrammatical illustration of an embodiment of this disclosure of a high pressure processing system 100 capable of achieving temperature control of product, during high pressure processing, while FIGS. 2 and 3 are schematic illustrations of a high pressure processing system 300 illustrating the main components used in temperature control. Other features not shown are standard features of existing high pressure processing systems. In one embodiment, the systems can be used to process a product, such as milk, particularly in the range of about of about 45 to 65° C. FIG. 4 is a schematic illustration of a temperature control system showing the main components for use in high pressure processing.

Referring to FIG. 1, in one embodiment of high pressure processing, a basket 102 is used to contain one or more food packages, such as bottles, cartons, or pouches in which pumpable products can be treated by the high pressure processing system 100 while being temperature controlled within a range. However, the disclosure is not limited to liquid pumpable products and can also apply to non-pumpable and solid products. It is to be understood that a basket 102 is merely representative of one example for holding the products to be processed in the system 100. Other containers can be used. Additionally, the applications entitled “Reusable Container for Bulk Processing in High Pressure Application,” U.S. Provisional Application No. 63/001,119, filed on Mar. 27, 2020, and “Container and Load basket for Thermal Management for Processing in High Pressure Application,” U.S. Provisional Application No. 63/001,047, filed on Mar. 27, 2020, are both incorporated herein expressly by reference for any and all purposes.

In high pressure processing, when the pressure media and the product is pressurized, the adiabatic temperature rise will increase the temperature of both the pressure media and the product. A typical temperature rise is about 3° C. per 1,000 bar, resulting in about 18° C. for a normal operating pressure of 6,000 bar. Once the pressure is released, the temperature decreases. It is understood that different materials, food, and pressure media may gain different adiabatic temperature increases.

However, even given the pressure condition of 6,000 bar, the adiabatic temperature increase is not sufficient to achieve temperature ranges of about 45 to 65° C. Further, since high pressure applications are run in chilled environment rooms, the entire equipment for the high pressure application has a low temperature. During hold times, the system will chill both the pressure media and the product that is exposed to the pressure media to the generally low temperature room environment. The cooling of the pressure media and product during hold times will result in the unfavorable condition that the desired temperature accuracy during the entire press cycle is also not achieved. The present disclosure therefore provides a system that is able to control temperatures at certain locations of the process, including the pressure media temperature, the product temperature itself, and also computes the adiabatic temperature rise for a given pressure, which makes accurate temperature control possible in combination with high pressure processing.

The present disclosure provides a high pressure processing system with temperature control of processing locations or the product itself by means of collecting data, evaluating data, and adjusting external parameters that will affect the product temperature.

In an example, an external parameter that is temperature controlled is the water or pressure media that will benefit from the adiabatic temperature rise. A heat exchanger 316 can be suitable for this purpose (see FIG. 2).

In an example, another external parameter to achieve heating and/or cooling of the processing temperature and product temperature is by means of temperature control of the oil-filled jacket 324 surrounding the pressure vessel 326 (see FIG. 2). The oil-filled jacket 324 is the void that exists between the outermost layer of the pressure vessel 326 and the surrounding sheet casing. This void is normally filled with oil to reduce condensation, for example. However, in one embodiment, an auxiliary oil heating and cooling system 332 is connected to heat and cool this oil. With accurate control of the oil temperature there is no risk for any overheating the pressure vessel 326 and its internal parts. In this disclosure, oil is described as a heat transfer media, however, the disclosure can be practiced with other any heat transfer media suited for the purpose.

In an embodiment, owing to the mass of the pressure vessel 326, the heat provided by the auxiliary oil heating and cooling 332 and the pressure media heat exchanger 316 may not suffice to respond quickly to bring incoming product up to the desired temperature range. High pressure processing times of some product can range from a few seconds to several minutes. Accordingly, in one embodiment, the incoming product, in the basket 102 or other container, that is going to be processed should be thoroughly temperature controlled to have reproducible repeatable results as far as reaching a desired temperature. To this end, the incoming product temperature needs to be fairly stable and consistently within a desired temperature range from basket to basket or other container. A temperature sensor 322I can be used to measure the temperature of the incoming product located in the basket 102, see FIG. 1. Such temperature sensor 322I can be a thermal scanner, for example.

To further aid in stabilizing the incoming product temperature prior to high pressure processing, the product may be cooled or heated to within a predetermined temperature range, or the product can be allowed a period of time to reach the room temperature.

The temperature of a product leaving the pressure vessel can also be measured by a temperature sensor 322m and the temperature used in any control loop for adjusting the temperature of the product before or during high pressure processing.

Temperature measurements of food can be done by temperature sensors that are in contact with the food but also with other type of sensors e.g. infrared or thermal imaging cameras.

Continuing to refer to FIG. 2, generally, the pressure vessel 326 functions to subject product 320 to high pressure using a high pressure media, such as water. For this purpose, the system 300 is equipped with pressure media pumping and decompression systems.

The high pressure vessel 326 is supported on a frame comprised of a longitudinal frame structure 302 and end frame structure 304. The frame structure is any rigid structure capable of providing the structural functionality for the high pressure processing described herein.

In order to keep the pressure media inside the pressure vessel 326, in one embodiment, there is one closure/plug 306, 308 at each end of the pressure vessel 326. Closures 306, 308 are free floating and will be pushed outwards during pressurization. The closures 306, 308 are held in place with the frame 302 acting as a yoke.

However, the present disclosure can also apply to different pressure vessel designs. For example, the pressure vessel can use different designs of frames/yokes and both wire wound frames as well as plate frames.

The present disclosure also applies to smaller pressure vessels that may omit a frame. In which case, the closures are held in place with another type of locking system, such as a pin closure design, interrupted thread design etc.

The pressure vessel can also use different designs of cylinders and both wire wound cylinders/vessel as well as monolithic cylinder/vessel that are able to withstand the high pressure described in this application.

Adding a temperature control system to a high pressure processing system can be adapted to the particular type of pressure vessel. Temperature control systems may use existing systems, such as oil-filled jackets and water heat exchangers, by re-fitting these systems with temperature sensors connected to a controller.

In other embodiments, a completely new temperature control system may have to be added to the high pressure processing system, including pressure vessels that do not include oil-filled jackets. For example, a heat blanket can be substituted for an oil-filled thermal jacket as a temperature control system.

In one embodiment, the high pressure processing system 300 also includes one or more high pressure pump(s) 310, water module(s) 312, electrical cubicle(s) including a programmable logic controller 314 and the communication cables, and other significant components, material handling, and auxiliary hydraulic unit(s).

In one embodiment, the water module 312 provides the pressure vessel 326 with water during pre-fill as well as all high pressure pumps/intensifiers during the pressure level increasing step.

The water that the water module 312 provides to the pressure vessel 326 is normally chilled by means of the heat exchanger 316 in order to keep the process as cold as possible, normally within 2-30° C. That temperature span has been found to be optimal from both a process as well as a component life length point of view. In one embodiment, the water module 312 in addition to the heat exchanger 316 is also equipped with heating elements to be able to adjust the water temperature to what is required to implement temperature control of the high pressure processing system.

In one embodiment, the heat exchanger can be provided with a heat transfer media or a coolant to provide either heating or cooling of the water or both.

When the water from the water module 312 fills the pressure vessel 326, the pre-filled water volume has the set temperature. When the high pressure pumps 310 start to increase the pressure level in the pressure vessel 326 the pumps 310 are provided with water from the water module 312 (with the pre-set water temperature) but as the pressure increases inside the pressure vessel 326 and high pressure tubing, the adiabatic temperature rise raises the temperature of the water and the product that is being processed. A typical adiabatic temperature rise is 3° C. per 1,000 bar i.e. 18° C. at 6,000 bar.

During hold time, normally between 30 seconds and 15 minutes, the temperature increase or decrease of the pressure media (water) inside the pressure vessel 326 is controlled by measuring temperatures at certain locations by a plurality of temperature sensors 322a-n. Temperature sensors 322a-n can use any technology for measuring temperature, including, but not limited to thermocouples, thermistors, resistance temperature detectors (RTD), infrared camera, thermal imaging camera, and the like.

A programmable logic controller 314 uses any one or more of the temperature measurements in feedback and/or feedforward control loops. Accordingly, when the process temperature is high according to a particular pre-programmed logic, there may be a need for applying cooling of the pressure media or the oil of the oil-filled jacket 324, while in cases when the process temperature is low there may be a need for heating of the pressure media or oil. Process temperature can refer to any of the locations designated herein, or any other suitable location where it would be advantageous. In some examples, the temperature of the pressure media and oil is used for controlling an internal temperature of the system or of the product 320 itself.

In some cases, the metal parts will see an increase in temperature and then reach a temperature steady state with the more cycles that are run in the pressure vessel 326. It is then of importance to fine tune and adjust temperatures at the pre-programmed settings. In an embodiment, the controller 314 can compensate for this initial increasing temperature followed by a steady temperature plateau.

To illustrate, during a pressure cycle, the controller 314 may aim for both product, vessel and pressure media to about the same initial temperature (e.g., 37° C.). Due to the adiabatic temperature rise, the pressure media and the product may climb to a similar temperature (e.g., 55-57° C.) at full pressure. Since the pressure vessel 326 is slow to respond due to the large mass of metal, the inside of the pressure vessel 326 may get slightly warmer and show a temperature that is slightly higher than the initial temperature (e.g., 37° C.). When consecutive cycles are run (each cycle with new baskets/milk/food stuff) it may be possible that the inner surface of the pressure vessel 326 will experience a “steady” increase of its inner surface temperature. In an embodiment, the controller 314 is programmed with a recipe to compensate for this increase in the temperature of the inside of the pressure vessel 326 after each in a series of consecutive cycles and responds by reducing either the vessel temperature or the incoming product temperature a small amount, for example, until the pressure vessel 326 temperature has plateaued. Accordingly, the risk that milk/food stuff will be exposed to too high temperatures is reduced or eliminated.

In an embodiment, it is possible product will be subjected to more than one cycle. In this case, the controller 314 is programmed with a recipe that compensates for the temperature increase during each cycle. The recipe can be validated by performing learning trials before the recipe is used for actual production of product.

When certain product, such as dairy products, is being processed it is important to reach certain product temperatures for a certain period of time (hold time) and in order to reach the temperature within reasonable tolerances the combination of temperature control of pressure media, oil in the oil-filled jacket 324, the adiabatic temperature rise, as well as the additional heating or cooling from the ambient temperature in the room where the high pressure processing takes place are controlled by the programmable logic controller 314. Accordingly, high pressure processing of dairy products at pressures above 2,000 bar and at a temperature range from about 40° C. to about 65° C. and higher is provided by the system illustrated in FIGS. 2 and 3.

The system is not limited to dairy products or the forgoing temperatures. As discussed above, the system according to this disclosure may be used for Pressure Assisted Temperature Sterilization (PATS) or Temperature Assisted Pressure Sterilization (TAPS. For example, the system may use operating temperatures of at least 130° C. or higher in situations for both elevated temperatures and pressures are used for sterilization. Such operating pressures may be as high as 8,000 bar or even higher.

In one embodiment, the controller 314 controls one or more of the inlet water temperature to the pressure vessel 326, calculates the adiabatic temperature rise of the system, controls the temperature of the oil in the oil-filled jacket 324, and may control the room temperature. To calculate the adiabatic temperature rise, the controller 314 includes a program module for calculating the adiabatic temperature rise. Such module may use the specific heat capacities of the pressure media (water) and the metals, a calculated volume of metal in contact with the pressure media, the room temperature, and the product temperature, for example. The adiabatic temperature rise can also be pre-calculated and stored into a table accessible by the controller 314. Such table can be based on empirical data and/or from real measurements.

Additionally, in one embodiment, the temperature of the final product that may also be part of the feedback loop i.e. temperature adjustments made based on food “quality.”

In an embodiment, the temperature increase or drop can be fine-tuned by means of the oil-filled thermal jacket 324 where temperature can either be increased or decreased depending on what is needed to maintain temperature parameters. The increase or decrease of thermal jacket 324 temperature is preferably achieved by means of the temperature controlled oil that is circulated between the wire wound pressure vessel 326 and the inside of the vessel sheet casing. Although the thermal jacket 324 is described as using oil, this disclosure is not limited to oil. In some embodiments, any heat transfer medium may be used in the void of the thermal jacket 324.

A plurality of thermocouples (or other temperature sensors) 322a-n will be used to collect temperature data at different locations to be used within the control/feedback loop to adjust temperature parameters at selected locations. The selection of locations is merely representative of one embodiment, and fewer or more temperature sensors can be used in other locations.

Referring to FIG. 2, an example where temperature sensors are designated are as follows. This list is not meant to be exhaustive. The number of temperature sensors may be more or less depending on the particular application.
322a—pressure media temperature at water module 312.
322b—pressure media temperature after high pressure pump 310.
322c—pressure media temperature to pressure vessel 326.
322d—pressure media temperature to pressure vessel 326.
322e—temperature inside pressure vessel 326.
322f—temperature inside pressure vessel 326.
322g—temperature of thermal jacket 324.
322h—temperature of pressure vessel 326 wall.
322i—temperature of oil.
322j—temperature of return oil from jacket 324.
322k—temperature of pressure media from heat exchanger 316.
322I—temperature measurement of food packages entering the pressure vessel 326.
322m—temperature measurement of food packages leaving the pressure vessel 326.
322n—temperature measurement of product or food packages being pressurized.

With respect to the food product itself, temperature measurements of food can be done by sensors that are in contact with the food but also with other type of sensors e.g. infrared or thermal imaging cameras. Accordingly, the temperature of the food entering and leaving the pressure vessel 326 can also be registered by means of temperature sensors.

A controls/feedback loop can measure one or more of the temperatures indicated above to control the same temperature or a temperature of a different location. For example, both the pressure medium temperature and the oil temperature affect the temperature inside the pressure vessel 326. In one example, a controls/feedback loop includes temperature data, such as temperature from incoming water (temperature sensor 322a) to high pressure pump 310, outgoing water (temperature sensor 322b) from high pressure pump 310, incoming water (temperature sensors 322c, d) to pressure vessel 326, temperature (temperature sensors 322e, f) inside the pressure vessel 326, vessel wall temperature (temperature sensor 322h) as well as thermal jacket temperature (temperature sensor 322g).

In other embodiments, the same or different locations can be used for measuring temperature.

In one embodiment, in order to minimize any temperature drop/decrease from the high pressure pump 310 to the high pressure vessel 326 the high pressure tubing can be insulated. With a controlled and limited high pressure tubing temperature drop the temperature accuracy inside the pressure vessel 326 will increase.

In one example, the temperature of the oil, the temperature of the pressure media (water) are controlled by control logic residing on the programmable logic controller 314. In one example, one or more of the temperature sensors 322a to 322n are used in feedback loop control of the temperatures of the oil and pressure media.

FIG. 3 is a schematic illustration of an embodiment similar to the embodiment of FIG. 2, with the differences noted below. Similar components appearing in both FIGS. 2 and 3 are designated with the same component reference number.

In FIG. 3, the auxiliary oil heating/cooling block 332 is replaced with an electrical resistance heater 328 connected to a heat blanket 330. The heat blanket 330 can include resistance elements as a manner of providing heat. The heat blanket 330 can be wrapped over the exterior cylinder of the pressure vessel 326 to provide heat to keep a process temperature within a desired range. A temperature sensor 322o is provided on or in proximity to the heat blanket 330 to measure the temperature of the heat blanket 330 for use in one or more control loops executed by the controller 314. In an embodiment, the “void” that acts as the oil-filled thermal jacket 324 can be emptied of oil and replaced with insulation.

FIGS. 2 and 3 are representative embodiments to show at least one manner of controlling the processing temperatures of the pressure vessel 326 and its contents during pressurizing and the attendant adiabatic temperature rise. The embodiments of FIGS. 2 and 3 are not the sole manner of heating the pressure vessel and its contents. The heating and cooling of the pressure vessel 326 is not limited to the auxiliary oil, heat blanket, and the pressure media. Other heat generating systems or cooling systems can be used, including, but not limited microwave or radio-frequency systems or even resistance heaters built into the pressure vessel for heating, while refrigeration systems including compression systems, evaporative and absorption systems may be used for cooling. Typical refrigerants for mechanical compression systems use hydrofluorocarbons, chlorofluorocarbons, propylene, and the like, while evaporative and absorption systems can use ammonia and water. The heat exchanger 316 for heating the pressure media can also be supplemented or replaced with another manner of heating or cooling, such as those mentioned herein.

As mentioned above, in an embodiment, the incoming product, in basket 102 or other container, that is going to be processed should be thoroughly temperature controlled to have reproducible repeatable results as far as temperature controlling owing to factors, such as the large mass of the pressure vessel 326, the limited area for heat transfer to occur, etc. Therefore, the auxiliary oil heating and cooling 332 and the heat blanket 330 may be considered secondary systems for fine tuning or maintaining the desired temperature such as preventing or minimizing heat escape from the pressure vessel 326. In an embodiment, since the pressure media is in closer proximity to the product inside the pressure vessel 326, the pressure media temperature will be used as the primary means used in temperature control, such as to raise or lower the process temperature and/or the product temperature.

In an example, the controller 314 includes at least one processor and a system memory. Depending on the exact configuration and type of controller 314, the system memory may be volatile or nonvolatile memory, such as read only memory (“ROM”), random access memory (“RAM”), EEPROM, flash memory, or similar memory technology. Those of ordinary skill in the art and others will recognize that system memory typically stores data and/or program modules that are immediately accessible to and/or currently being operated on by the processor. In this regard, the processor may serve as a computational center of the controller 314 by supporting the execution of programmed logical instructions.

In an example, the controller 314 may include a network interface comprising one or more components for communicating with other devices over a network. As will be appreciated by one of ordinary skill in the art, the network interface may represent one or more wireless interfaces or physical communication interfaces described and illustrated above with respect to particular components of the controller 314.

In an example, the controller 314 also includes a storage medium. The storage medium may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory and storage medium are merely examples of computer-readable media. A non-transitory tangible computer readable medium may be used for storing instructions, which when executed by the controller 314 can perform steps, such as receiving one or more temperatures of one or more locations from the high pressure processing system; and heating or cooling the pressure media or the heat transfer media or both in response to the one or more temperatures deviating from a temperature range, and other steps for implementing temperature control described herein.

Suitable implementations of controller 314, system memory, communication bus, storage medium, and network interface are known and commercially available. For ease of illustration and because it is not important for an understanding of the claimed subject matter, FIGS. 2 and 3 do not show some of the typical components of many controllers. In this regard, the controller 314 may include input devices, such as a keyboard, keypad, mouse, microphone, touch input device, touch screen, tablet, and/or the like. Such input devices may be coupled to the controller 314 by wired or wireless connections.

In this disclosure, controller 314 includes instructions embodied in hardware or software for performing certain steps. Such instructions can be written in a programming language. The instructions may be compiled into executable programs or written in interpreted programming languages. The instructions can be stored in any type of computer-readable medium or computer storage device and be stored on and executed by the controller 314, thus creating a special purpose computer configured to provide the functionality thereof. The controller 314 is particularly used to control the heating and cooling of the oil and pressure media and/or performing a sequence of steps based on feedback from one or more of the temperature sensors 322a to 322o.

Referring to FIG. 4, the main components of a temperature control system 400 for a high pressure processing system are illustrated. The temperature control system 400 which is also present in FIGS. 1, 2, and 3 includes at least one controller 402 as described herein, a heater or cooler system 404 connected to affect the temperature of a high pressure vessel 406. The heater or cooler system 404 is any system capable of adding to or taking away heat from the pressure vessel 406. The heater or cooler system 404 is in communication with the controller 402. Several heater and cooler systems have been described in connection with FIGS. 2 and 3. However, FIG. 4 is not limited to any particular heater or cooler system.

The controller 402 is configured to control the heater or cooler system 404 to maintain a temperature of the pressure vessel 406 or a product therein in response to one or more temperatures deviating from a temperature range while the pressure vessel 406 undergoes pressurization and the attendant adiabatic temperature increase.

The controller 402 receives temperature signals over communications line 412 from the heater or cooler system 404 and temperature signals over communications line 414 from the pressure vessel 406 or products therein. Temperature signals are those produced by the temperature sensors described herein, such as temperature sensors 322a to 322o (see FIGS. 2 and 3), but may include other temperature sensors as well from other locations. The controller 402 then uses the temperature signals to send an output over the communications line 408 calculated to bring or maintain a temperature to within a desired range. The temperature that is desired to be within a range can be a temperature of the heater or cooler system 404 or of the pressure vessel 406 or product therein.

Some temperatures may be inferred, for example, if a product temperature is desired to be controlled, then, the product temperature need not be directly measured, but can be inferred by holding other temperatures within the desired range.

The controller 402 may send a signal, for example, to increase the rate of flow of a heat transfer medium or refrigerant to the pressure vessel 406 or to increase the current to an electrical resistance heater on the pressure vessel 406. The heater or cooler system 404 responds by adding heat to the pressure vessel 406 or removing heat from the pressure vessel 406 thereby also affecting the product temperature itself. A high pressure processing system with temperature control as described can have advantages.

In one embodiment, the high pressure processing system eliminates the influence on high pressure processing of dairy products from the ambient temperature by usage of a thermal jacket that can be used for either heating or cooling of the pressure vessel to maintain processing temperatures within a range.

In one embodiment, the high pressure processing system controls the temperature of the pressure media used for high pressure pumping, and is adjusted and kept within the determined temperature span to allow for precise high pressure processing of dairy products in the temperature range of about 45 to 65° C.

In one embodiment, the high pressure vessel temperature is controlled by means of a thermal jacket filled with oil that is either heated or chilled to meet processing temperatures.

In one embodiment, the high pressure processing system provides a method to accurately control the process temperature for dairy products by combining temperature data for incoming and outgoing high pressure media from high pressure pumps, vessel wall temperature as well as the thermal jacket temperature, and the adiabatic temperature rise.

In one embodiment, the high pressure processing system can analyze multiple temperatures from multiple locations on the high pressure processing system and make temperature corrections according to a programmed recipe.

In one embodiment, the high pressure processing system provides a method to narrow process temperature tolerances to a minimum by using control logics and built in measurement devices and temperature sensors.

While illustrative embodiments have been illustrated and described, it will be appreciated that various changes can be made therein without departing from the spirit and scope of the invention.

1. A high pressure processing system, comprising:
a pressure vessel configured to receive a basket or container inside the pressure vessel;
a high pressure pump configured to pump a pressure media to the pressure vessel to raise pressure in the pressure vessel;
a controller configured to control a heater or cooler system to maintain a temperature of the pressure vessel or a product therein in response to one or more temperatures deviating from a temperature range while the pressure vessel undergoes pressurization; and
an oil-filled jacket containing an oil for reducing condensation, characterized in that an auxiliary heater/cooler is connected to the oil-filled jacket to heat or cool the oil.

2. The high pressure processing system of claim 1, comprising a thermal jacket, wherein the thermal jacket at least partly surrounds the pressure vessel, and the thermal jacket contains heat transfer media that is heated or cooled.

3. The high pressure processing system of claim 1, comprising a heat exchanger to heat and cool the pressure media.

4. The high pressure processing system of claim 1, comprising an electrically heated heat blanket surrounding the pressure vessel.

5. The high pressure processing system of claim 1, wherein the high pressure pump can raise the pressure media to a pressure of at least 2,000 bar, or at least 4,000 bar, or at least 6,000 bar.

6. The high pressure processing system of claim 1, further comprising a controller having a non-transitory tangible computer readable medium with instructions stored thereon, which when executed by the controller perform the steps of:
receiving one or more temperatures of one or more locations from the high pressure processing system; and
heating or cooling a pressure media or a heat transfer media or both in response to the one or more temperatures deviating from a temperature range.

7. The high pressure processing system of claim 6, wherein the instructions further comprise performing the step of calculating the adiabatic temperature rise in the pressure media for a given pressure.

8. The high pressure processing system of claim 6, wherein the instructions further comprise performing the step of calculating the adiabatic temperature rise in the pressure vessel for a given pressure.

9. The high pressure processing system of claim 6, wherein the instructions further comprise performing the step of calculating the adiabatic temperature rise in a product for a given pressure.

10. The high pressure processing system of claim 6, wherein temperatures are measured at one or more of the following locations:
a temperature of the product that is going to be processed,
a temperature of the pressure media before the high pressure pump or pumps,
a temperature of the pressure media after the high pressure pump or pumps,
a temperature of the pressure media to the pressure vessel,
a temperature inside the pressure vessel,
a temperature of a thermal jacket,
a temperature of a pressure vessel wall,
a temperature of a heat transfer media before the thermal jacket,
a temperature of a heat transfer media from the thermal jacket,
a temperature of the pressure media after a heat exchanger,
a temperature of a room in which the high pressure processing system is located,
a temperature of a food or product that is entering the pressure vessel,
a temperature of a food or product that is leaving the pressure vessel, and
a temperature of a food or product when being pressurized.

11. A method for high pressure processing of a product in the high pressure processing system of claim 1, comprising:
placing a container or basket with a product within a pressure vessel;
filling the pressure vessel with a pressure media;
increasing the pressure in the pressure vessel to at least 2,000 bar; and
controlling a process or product temperature in the pressure vessel above or below a temperature that is due to an adiabatic temperature rise from the increase in pressure.

12. The method of claim 11, wherein the adiabatic temperature rise is about 3° C. per 1,000 bar, and the process or product temperature is controlled to be above the adiabatic temperature rise.

13. The method of claim 11, wherein the process or product temperature in the pressure vessel is controlled from about 40° C. to about 65° C.

14. The method of claim 11, wherein the product is a dairy product.

15. The method of claim 11, further comprising, with a controller, calculating the adiabatic temperature rise of the pressure media due to the increase in pressure within the pressure vessel.

16. The method of claim 11, further comprising, with a controller, calculating the adiabatic temperature rise inside the pressure vessel due to the increase in pressure within the pressure vessel.

17. The method of claim 11, further comprising controlling a temperature of the pressure media or a heat transfer media in a thermal jacket surrounding the pressure vessel.

18. The method of claim 11, further comprising controlling a temperature of a heat blanket surrounding the pressure vessel.

19. The method of claim 17, wherein the pressure media and the heat transfer media can be heated and cooled.

20. The method of claim 11, further comprising measuring a temperature at one or more locations selected from the group consisting of:
a temperature of the product to be processed,
a temperature of the pressure media before a high pressure pump,
a temperature of the pressure media after the high pressure pump,
a temperature of the pressure media to the pressure vessel,
a temperature inside the pressure vessel,
a temperature of the thermal jacket,
a temperature of a pressure vessel wall,
a temperature of the heat transfer media before the thermal jacket,
a temperature of the heat transfer media from the thermal jacket,
a temperature of the pressure media after a heat exchanger, and
a temperature of a room in which the pressure vessel is located,
a temperature of a food or product that is entering the pressure vessel,
a temperature of a food or product that is leaving the pressure vessel, and
a temperature of a food or product when being pressurized.

21. The method of claim 11, further comprising holding the product at a high pressure and process temperature according to a recipe stored in a controller.
